(19) United States
(12) Patent Application Publication
(10) Pub. No.: US 2023/0083523 A1
(43) Pub. Date: Mar. 16, 2023

(54) MULTI-PROCESSOR SYSTEM AND BOOTING METHOD THEREOF

(71) Applicant: Xunmu Information Technology (Shanghai) Co., Ltd., Shanghai (CN)

(72) Inventor: Jiang WANG, Shanghai (CN)

(73) Assignee: Xunmu Information Technology (Shanghai) Co., Ltd., Shanghai (CN)

(21) Appl. No.: 17/850,303

(22) Filed: Jun. 27, 2022

(30) Foreign Application Priority Data
Sep. 13, 2021 (CN) 202111068587.6

(51) Int. Cl. G06F 9/4401

(52) U.S. Cl. CPC G06F 9/441; G06F 9/4405; G06F 9/442

(57) ABSTRACT

Disclosed is a multi-processor system, which includes a master processor, a non-volatile memory and a plurality of slave processors. The non-volatile memory is used to store first boot firmware and second boot firmware. Each slave processor includes a JTAG port, and each JTAG port is respectively connected to one I/O port of the master processor. When the master processor is powered on or rebooted, it reads the first boot firmware and performs a booting process. After the master processor completes the booting process, it establishes communication connections with the plurality of slave processors, releases a reset signal to the plurality of slave processors respectively to control the startup of the plurality of slave processors, and reads the second boot firmware and transmits the second boot firmware to the plurality of slave processors respectively to make the plurality of slave processors booted according to the received second boot firmware.

### CROSS REFERENCE TO RELATED APPLICATION

This application claims the priority benefit of Chinese Patent Application Serial Number 202111068587.6, filed on Sep. 13, 2021, the full disclosure of which is incorporated herein by reference.

### BACKGROUND

### Technical Field

The present disclosure relates to the technical field of micro-processing, and in particular to a multi-processor system and a booting method thereof.

### Related Art

In order to obtain higher computing power and improve performance, more and more computer devices adopt circuit architectures containing multiple processors (i.e., a multi-processor system).

In a common multi-processor system, each processor is connected to a non-volatile memory, which stores the boot firmware of the processor, and multiple processors are connected through a network exchange chip or a bus to communicate with each other. The booting method of the multi-processor system includes the steps of: reading, by each processor, the boot firmware from an external non-volatile memory connected after the multi-processor system is powered on or rebooted; starting up, by each processor, according to the boot firmware; and loading, by each processor, an operating system and application software after the startup is successful.

However, the above-mentioned multi-processor system has the following shortcomings. (1) The number of non-volatile memories increases with an increase in the number of processors, so that the circuit board density, wiring complexity, and product cost of computer devices also increase accordingly. (2) The boot firmware of each processor is stored in an external non-volatile memory each processor connected, so that the upgraded boot firmware must be burned into each non-volatile memory when the boot firmware of each processor needs to be upgraded, resulting in the problems of increased operation complexity, error-proneness, and increased difficulty in maintenance and management of the boot firmware.

### SUMMARY

The present disclosure provides a multi-processor system and a booting method thereof, which can effectively solve the problems of increased operation complexity and error-proneness of the upgrade of the boot firmware, and increased difficulty in maintenance and management of the boot firmware, and of higher circuit board density, wiring complexity and product cost of the computer device, which adpots the multi-processor system, since each processor in the multi-processor system is connected to a non-volatile memory that stores its boot firmware in the prior art.

In order to solve the above technical problem, the present disclosure is implemented as follows.

The present disclosure provides a multi-processor system, which comprises a master processor, a non-volatile memory, and a plurality of slave processors. The non-volatile memory is connected to the master processor, and is configured to store first boot firmware and second boot firmware. Each of the plurality of slave processors comprises a joint test action group (JTAG) port, and each JTAG port is connected to one input and output (I/O) port of the master processor. When the master processor is powered on or rebooted, the master processor reads the first boot firmware and performs a booting process. After the master processor completes the booting process, it establishes communication connections with the plurality of slave processors respectively, and releases a reset signal to the plurality of slave processors respectively to control the startup of the plurality of slave processors, and reads the second boot firmware and transmits the second boot firmware to the plurality of slave processors through the communication connections to make the plurality of slave processors booted according to the received second boot firmware.

The present application provides a booting method of a multi-processor system, which comprises: reading, by a master processor, first boot firmware stored in a non-volatile memory when the master processor is powered on or rebooted and performing a booting process; establishing, by the master processor, communication connections with a plurality of slave processors respectively after the master processor completes the booting process; releasing, by the master processor, a reset signal to the plurality of slave processors respectively to control the startup of the plurality of slave processors; and reading, by the master processor, second boot firmware and transmitting the second boot firmware to the plurality of slave processors through the communication connections to make the plurality of slave processors booted according to the received second boot firmware.

In the embodiments of the present disclosure, through the setting of a single non-volatile memory, the number of non-volatile memory used and its peripheral components are reduced, and the circuit board density and the wiring complexity are reduced, thereby reducing the cost of the multi-processor system. In addition, since the single non-volatile memory stores the first boot firmware of the master processor and the second boot firmware of the slave processor, the upgrade operation of the first boot firmware and the second boot firmware is simple, and the management and maintenance of the first boot firmware and the second boot firmware are more convenient.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The FIGures are for illustration purposes only and are not drawn to scale. The exemplary embodiments, both as to organization and method of operation, may best be understood by reference to the detailed description which follows taken in conjunction with the accompanying drawings in which:

FIG. 1 is a schematic structural diagram of a multi-processor system according to a first embodiment of the present disclosure.

FIG. 2 is a schematic structural diagram of a multi-processor system according to a second embodiment of the present disclosure.

FIG. 3 is a schematic structural diagram of a multi-processor system according to a third embodiment of the present disclosure.

FIG. 4 is a schematic structural diagram of a multi-processor system according to a fourth embodiment of the present disclosure.

FIG. 5 is a schematic structural diagram of a multi-processor system according to a fifth embodiment of the present disclosure.

FIG. 6 is a schematic flowchart of a booting method of a multi-processor system according to an embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

It must be understood that when a component is described as being “connected” or “coupled” to (or with) another component, it may be directly connected or coupled to other components or through an intermediate component. In contrast, when a component is described as being “directly connected” or “directly coupled” to (or with) another component, there are no intermediate components. In addition, unless specifically stated in the specification, any term in the singular case also comprises the meaning of the plural case.

In the following embodiment, the same reference numerals are used to refer to the same or similar elements throughout the disclosure.

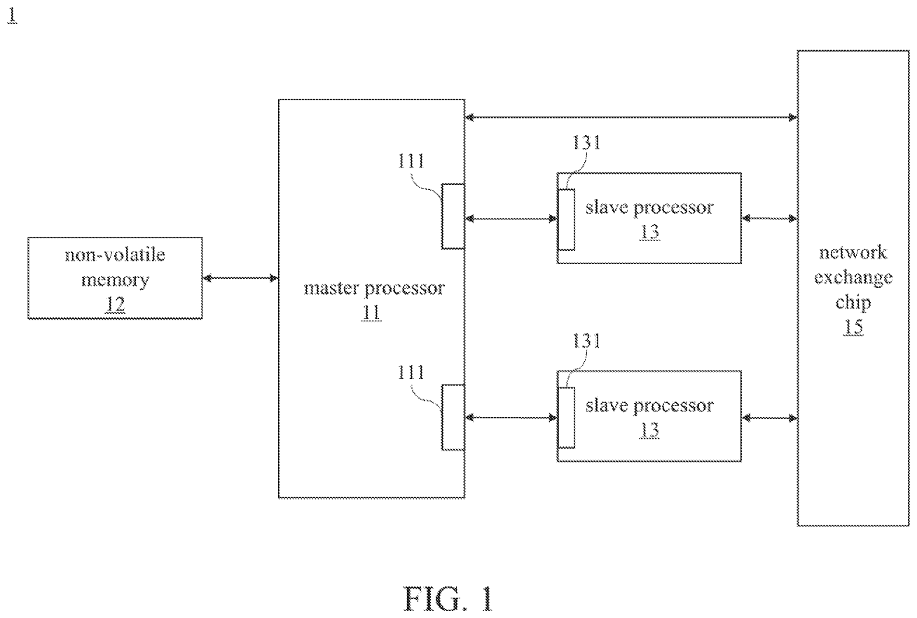

Please refer to FIG. 1, which is a schematic structural diagram of a multi-processor system according to a first embodiment of the present application. As shown in FIG. 1, the multi-processor system 1 comprises a master processor 11, a non-volatile memory 12 and a plurality of slave processors 13. The non-volatile memory 12 is connected to the master processor 11, and is configured to store first boot firmware and second boot firmware. Each of the plurality of slave processors 13 comprises a joint test action group (JTAG) interface 131, and each JTAG port 131 is connected to one one input and output (I/O) port 111 of the master processor 11. When the master processor 11 is powered on or rebooted, it reads the first boot firmware and performs a booting process. After the master processor 11 completes the booting process, it establishes communication connections with the plurality of slave processors 13 respectively, and releases a reset signal to the plurality of slave processors 13 respectively to control the startup of the plurality of slave processors 13, and reads the second boot firmware and transmits the second boot firmware to the plurality of slave processors 13 respectively through the communication connections to make the plurality of slave processors 13 booted according to the received second boot firmware respectively.

In more detail, the multi-processor system 1 comprises a plurality of processors. Among the plurality of processors, one processor is selected as the master processor 11, and the remaining processors are used as the plurality of slave processors 13. The default level of the reset pin 132 of all slave processors 13 is low level, so that all slave processors 13 are in the reset state. When the master processor 11 is powered on or rebooted, the master processor 11 reads its own boot firmware (that is, the first boot firmware) from the external non-volatile memory 12 and performs the booting process. After the master processor 11 completes the booting process, the master processor 11 releases the reset signal to each slave processor 13 (i.e., pulling up the level of the reset pin 132 of all slave processors 13) to turn all the slave processors 13 from the reset state to the startup state (i.e., starting up all the slave processors 13). Then, the master processor 11 reads the boot firmware of the slave processor 13 (that is, the second boot firmware) from the external non-volatile memory 12, and simulates the included I/O ports 111 as the JTAG ports to transmit the second boot firmware to all slave processors 13 through the JTAG port 131 included in each slave processor 13, so that all the slave processor 13 are booted according to the received second boot firmware respectively.

In an example, the master processor 11 may respectively transmit the second boot firmware to all the slave processors 13 at different time points, so that all the slave processors 13 can be booted one after another.

In another example, the master processor 11 can transmit the second boot firmware to all the slave processors 13 at the same time, which realizes the parallel booting of all the slave processors 13, so that the booting time of the multi-processor system 1 is shortened and the booting efficiency of the multi-processor system 1 is improved.

In this embodiment, the non-volatile memory 12 may be, but is not limited to, a read only memory (ROM), a programmable read-only memory (PROM), an erasable programmable read-only memory Memory (EPROM), an electrically erasable programmable read-only memory (EEPROM), a ferromagnetic random access memory (FRAM), a flash memory, a magnetic surface memory, an optical disk, or a compact disc read-only memory (CD-ROM), wherein the magnetic surface memory can be a magnetic disk storage or a magnetic tape storage. In addition, the non-volatile memory 12 is only immovably connected to the master processor 11, but can be selectively connected to a burning device to upgrade the stored first boot firmware and second boot firmware. In an example, the non-volatile memory 12 only stores the first boot firmware and the second boot firmware. In another example, the non-volatile memory 12 can store operating systems and application software in addition to the first boot firmware and the second boot firmware.

In this embodiment, the number of slave processors 13 may be but not limited to two, the number of I/O ports 111 of the master processor 11 may be but not limited to two, and the number of slave processors 13 and I/O ports 111 may be adjusted based on the actual demands. It should be noted that the number of I/O ports 111 needs to be greater than or equal to the number of slave processors 13; and when the number of I/O ports 111 is less than the number of slave processors 13, the master processor 11 can connect to all of the slave processors 13 through the setting of the expansion chip, which will be set forth below.

In this embodiment, after the master processor 11 completes the booting process, it can also load the required operating system and application software from other external storage media (not shown). The external storage medium from which the master processor 11 loads the operating system and application software can be determined by the first boot firmware.

In an embodiment, after being successfully booted according to the second boot firmware, each slave processors 13 sends a booting success message to the master processor 11 through the communication connection. Therefore, the master processor 11 can obtain the status of each slave processor 13 (i.e., whether each slave processor 13 is successfully booted). In addition, after being successfully booted according to the second boot firmware, each slave processors 13 can also load the required operating system and application software from other external storage media (not shown), wherein the external storage medium from which each slave processors 13 loads the operating system and application software can be determined by the second boot firmware.

In an embodiment, when the master processor 11 does not receive the booting success message from a certain slave processors 13 within the default time after the second boot firmware is transmitted to the certain slave processor 13, the master processor 11 controls the certain slave processor 13 to restart, and retransmits the second boot firmware to the certain slave processor 13 through the communication connection, so that the certain slave processors 13 is rebooted again according to the second boot firmware.

In more detail, the master processor 11 transmits the second boot firmware to a certain slave processor 13 and starts timing. When the master processor 11 does not receive the booting success message sent by the certain slave processor 13 after the default time, the master processor 11 confirms that the certain slave processors 13 has failed to be booted. Therefore, the master processor 11 can take the initiative to pull down the level of the reset pin 132 of the certain slave processor 13 that has failed to failed to be booted, and then pull it up again, so that the certain slave processor 13 that has failed to be booted can restart. Then, the master processor 11 can retransmits the second boot firmware read from the non-volatile memory 12 to the restarted slave processor 13 through the communication connection, so that the certain slave processor 13 is booted again according to the second boot firmware. In this embodiment, the master processor 11 can actively reboot the slave processor 13 that has failed to be booted, so as to improve the reliability of the booting of the multi-processor system 1. The amount of the default time can be set according to the actual test situation of the multi-processor system 1 by adding a certain margin. Therefore, the amount of the default time can be adjusted and set according to actual requirements.

In an embodiment, when the master processor 11 receives the booting success message sent by all the slave processors 13 within the default time after the second boot firmware is transmitted to the plurality of slave processors 13 respectively, the master processor 11 can continue to load the required operating system and application software from the external storage medium.

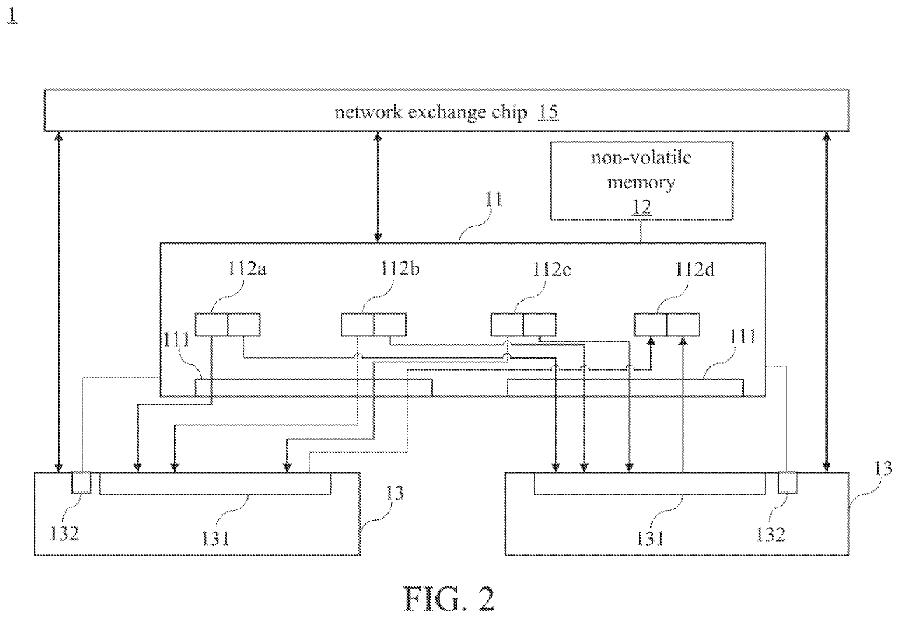

In an embodiment, please refer to FIG. 2, which is a schematic structural diagram of the multi-processor system according to a second embodiment of the present disclosure. As shown in FIG. 2, the master processor 11 also comprises a first register 112a, a second register 112b, a third register 112c, and a fourth register 112d, which are respectively connected to each I/O port 111 to control the I/O ports 111 to be simulated as the JTAG ports, so that the master processor 11 establishes the communication connections with the plurality of slave processors 13 through the JTAG port 131 included in each of the plurality of slave processors 13. The first register 112a is configured to output clock (TCK) signals to the plurality of slave processors 13 in parallel, the second register 112b is configured to output data input (TDI) signals to the plurality of slave processors 13 in parallel, the third register 112c is configured to output mode selection (TMS) signals to the plurality of slave processors 13 in parallel, and the fourth register 112d is configured to receive data output (TDO) signals from the plurality of slave processors 13 in parallel (i.e., the first register 112a, the second register 112b, the third register 112c, and the fourth register 112d are parallel registers). In other words, the master processor 11 is designed to connect to each I/O port 111 through the first register 112a, the second register 112b, the third register 112c, and the fourth register 112d that can output or receive signals in parallel, so that each I/O port 111 can output the clock signal, the data input signal, and the mode selection signal, and receive the data output signal (that is, each I/O port 111 can be simulated as a JTAG port). Therefore, the master processor 11 can establish a communication connection with each slave processors 13 including the JTAG port 131 through the I/O ports 111 simulated as the JTAG ports. In this embodiment, the master processor 11 can output the second boot firmware to the plurality of slave processors 13 in parallel through the second register 112b (that is, the master processor 11 transmits the second boot firmware to all slave processors 13 at the same time) to improve the booting efficiency of the multi-processor system 1.

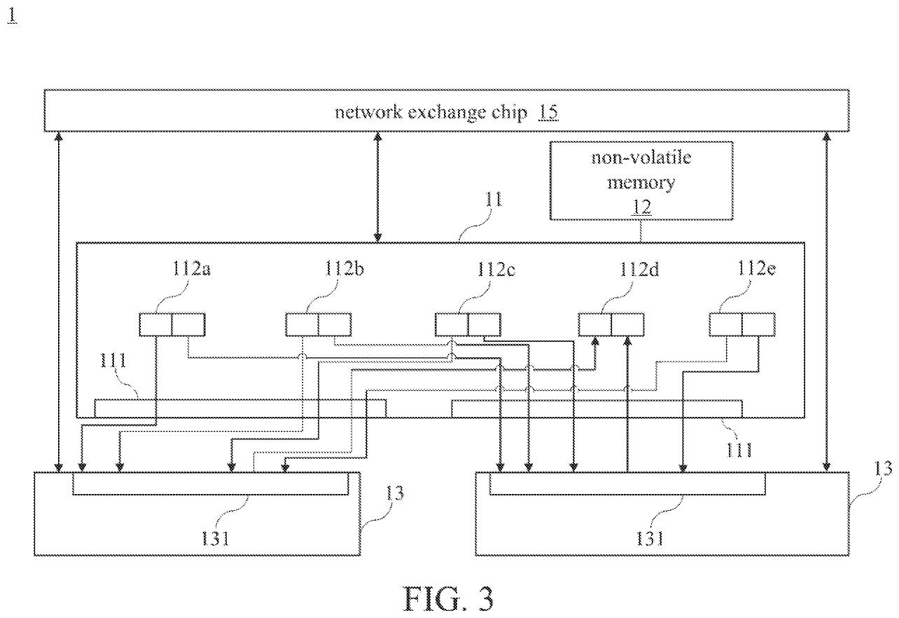

In an embodiment, the JTAG port 131 can receive the reset signal in addition to receiving the clock signal, the data input signal, and the mode selection signal, and outputting the data output signal. Therefore, please refer to FIG. 3, which is a schematic structural diagram of a multi-processor system according to a third embodiment of the present disclosure. As shown in FIG. 3, the master processor 11 may further comprise a first register 112a, a second register 112b, a third register 112c, a fourth register 112d, and a fifth register 112e, which are respectively connected to each I/O port 111 to control each I/O port 111 to be simulated as a JTAG port, so that the master processor 11 establishes the communication connections with the plurality of slave processors 13 through the JTAG port 131 included in each slave processor 13. The first register 112a is configured to output clock signals to the plurality of slave processors 13 in parallel, the second register 112b is configured to output data input signals to the plurality of slave processors 13 in parallel, the third register 112c is configured to output mode selection signals to the plurality of slave processors 13 in parallel, the fourth register 112d is configured to receive data output signals from the plurality of slave processors 13 in parallel, and the fifth register 112e is configured to output reset signals (TRST) to the plurality of slave processors 13 in parallel (that is, the first register 112a, the second register 112b, the third register 112c, the fourth register 112d, and the fifth register 112e are parallel registers). In this embodiment, the master processor 11 may output the reset signals to the plurality of slave processors 13 in parallel through the fifth register 112e (that is, the master processor 11 enables all the slave processors 13 to start at the same time).

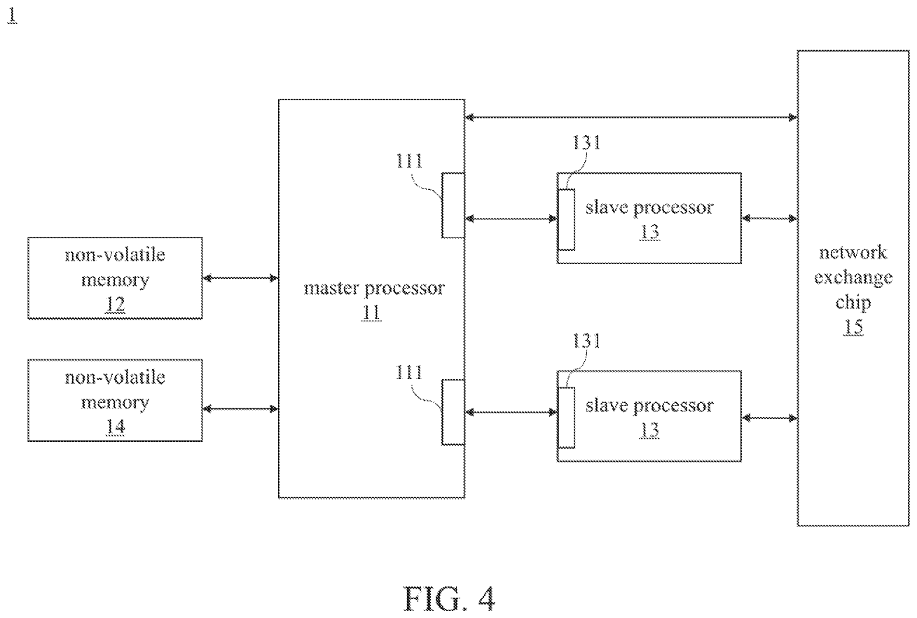

In an embodiment, please refer to FIG. 4, which is a schematic structural diagram of a multi-processor system according to a fourth embodiment of the present disclosure. As shown in FIG. 4, the multi-processor system 1 further comprises another non-volatile memory 14, which is connected to the master processor 11 and configured to store the second boot firmware, so that the master processor 11 can selectively read the second boot firmware from the non-volatile memory 12 or the another non-volatile memory 14.

In an embodiment, referring to FIGS. 1 to 4, the multi-processor system 1 further comprises a network exchange chip 15. The master processor 11 that has been successfully booted and the plurality of slave processors 13 can communicate with each other through the network exchange chip 15. The network exchange chip 15 may be, but not limited to, an Ethernet switching chip. In another embodiment, the multi-processor system 1 further comprises a bus (not shown), and the master processor 11 that has been successfully booted and the plurality of slave processors 13 communicate with each other through the bus.

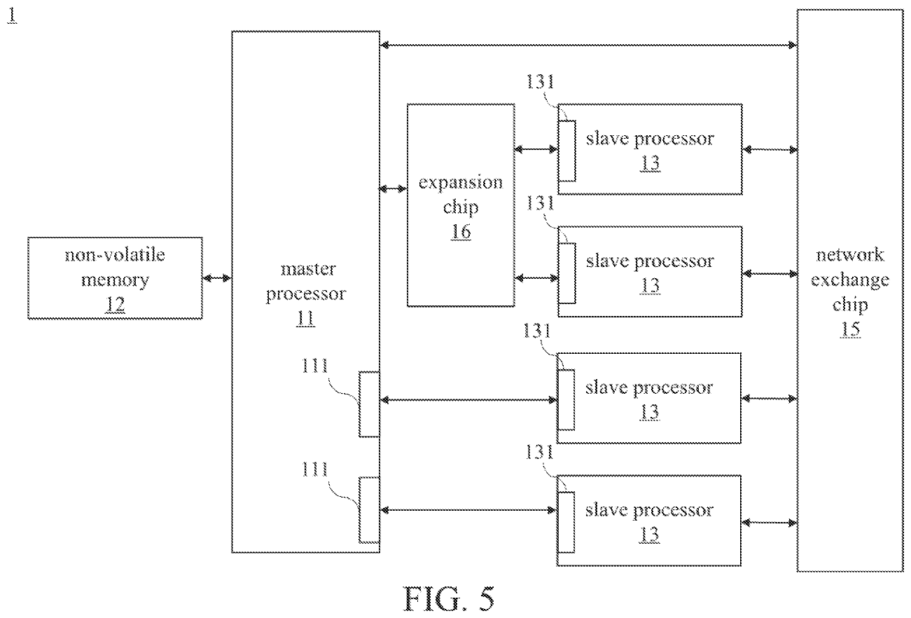

In an embodiment, when the number of I/O ports 111 is less than the number of slave processors 13, the master processor 11 can connect to all slave processors 13 through the setting of the expansion chip 16. Please refer to FIG. 5, which is a schematic structural diagram of a multi-processor system according to a fifth embodiment of the present disclosure. As shown in FIG. 5, the multi-processor system 1 further comprises an expansion chip 16 connected to the master processor 11 to allow the master processor 11 to connect to more slave processors 13. In this embodiment, the main processor 11 can be connected to four slave processors 13 by setting the expansion chip 16. However, this embodiment is not intended to limit the disclosure. The actual number of slave processors 13 the master processor 11 connects to can be adjusted by selecting an appropriate expansion chip 16 according to actual needs.

In an embodiment, the expansion chip 16 is a programmable logic device or an application specific integrated circuit (ASIC) chip.

In an embodiment, the programmable logic device is a complex programmable logic device (CPLD) or a field-programmable gate array (FPGA).

In an embodiment, the ASIC chip is an inter-integrated circuit (I2C) to general-purpose input/output (GPIO) chip.

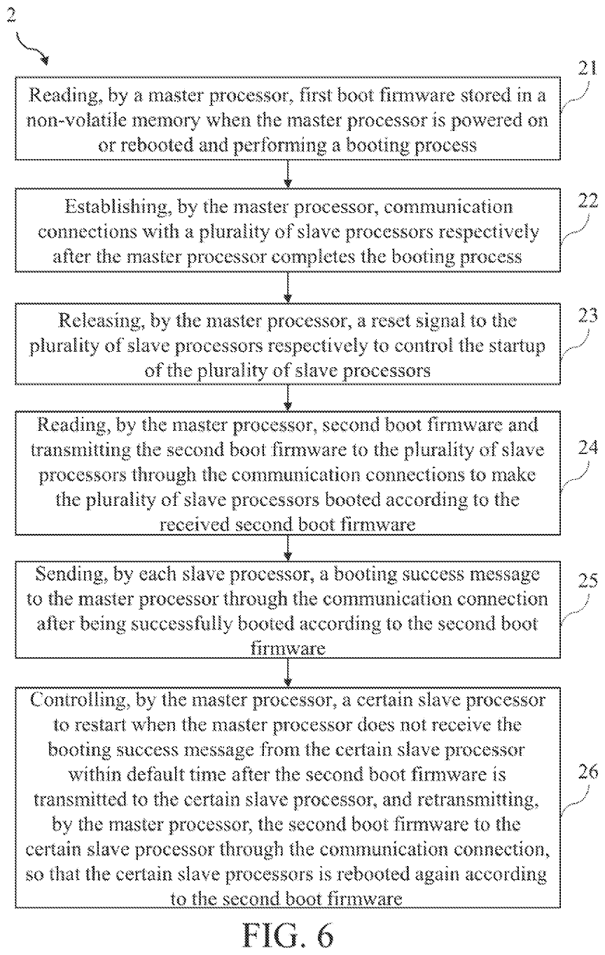

Please refer to FIG. 6, which is a schematic flowchart of a booting method of a multi-processor system according to an embodiment of the present disclosure. As shown in FIG. 6, the booting method 2 of the multi-processor system comprises: reading, by a master processor, first boot firmware stored in a non-volatile memory when the master processor is powered on or rebooted and performing a booting process (step 21); establishing, by the master processor, communication connections with a plurality of slave processors respectively after the master processor completes the booting process (step 22); releasing, by the master processor, a reset signal to the plurality of slave processors respectively to control the startup of the plurality of slave processors (step 23); and reading, by the master processor, second boot firmware and transmitting the second boot firmware to the plurality of slave processors through the communication connections to make the plurality of slave processors booted according to the received second boot firmware (step 24). The detailed description has been explained in the above paragraphs, and will not be repeated here.

In an embodiment, the step 22 may comprises: controlling, by the master processor, each I/O port to be simulated as a JTAG port through a first register, a second register, a third register, and a fourth register, so that the master processor establishes the communication connection with each slave processor through the JTAG port included in each slave processor, wherein the first register, the second register, the third register and the fourth register are respectively connected to each I/O port; the first register, the second register and the third register is configured to output clock signals, data input signals and mode selection signals to the plurality of slave processors in parallel respectively; and the fourth register is configured to receive data output signals from the plurality slave processors in parallel. The detailed description has been explained in the above paragraphs, and will not be repeated here.

In an embodiment, step 22 may comprise: controlling, by the master processor, each I/O port to be simulated as a JTAG port through a first register, a second register, a third register, a fourth register, and a fifth register, so that the master processor establishes the communication connection with each slave processor through the JTAG port included in each slave processor, wherein the first register, the second register, the third register, the fourth register, and the fifth register are respectively connected to each I/O port; the first register, the second register, the third register, and the fifth register are configured to output clock signals, data input signals, mode selection signals, and reset signals in parallel to the plurality of slave processors respectively; and the fourth register is configured to receive data output signals from the plurality slave processors in parallel. The detailed description has been explained in the above paragraphs, and will not be repeated here.

In an embodiment, the booting method 2 of the multi-processor system may further comprise: sending, by each slave processor, a booting success message to the master processor through the communication connection after being successfully booted according to the second boot firmware (step 25). Therefore, the master processor can obtain the status of each slave processor.

In an embodiment, the booting method 2 of the multi-processor system further comprise: controlling, by the master processor, a certain slave processor to restart when the master processor does not receive the booting success message from the certain slave processor within default time after the second boot firmware is transmitted to the certain slave processor, and retransmitting, by the master processor, the second boot firmware to the certain slave processor through the communication connection, so that the certain slave processors is rebooted again according to the second boot firmware (step 26). Therefore, the master processor can actively reboot the certain slave processor that has failed to be booted, thereby improving the reliability of the booting of the multi-processor system. The detailed description has been explained in the above paragraphs, and will not be repeated here.

In summary, in the embodiments of the present disclosure, through the setting of a single non-volatile memory, the number of non-volatile memory used and its peripheral components are reduced, and the circuit board density and the wiring complexity are reduced, thereby reducing the cost of the multi-processor system. In addition, since the single non-volatile memory stores the first boot firmware of the master processor and the second boot firmware of the slave processor, the upgrade operation of the first boot firmware and the second boot firmware is simple (the burning device only needs to be connected to the single non-volatile memory to burn the upgraded first boot firmware and the upgraded second boot), and the management and maintenance of the first boot firmware and the second boot firmware are more convenient. Furthermore, through the design that each slave processor needs to send a booting success message to the master processor after being successful booted according to the second boot firmware, the master processor has the ability to detect the status of each slave processor, wherein if a certain slave processor fails to be booted, the master processor can actively reboot the certain slave processor, which improves the reliability of the booting of the multi-processor system. Moreover, the master processor simulates the I/O ports as the JTAG ports by the setting of the parallel registers to establish the communication connections with the plurality of slave processors, which can realize parallel booting of all slave processors, shorten the booting time of the multi-processor system, and improve the booting efficiency of the multi-processor system.

It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. A multi-processor system, comprising:
a master processor;
a non-volatile memory, connected to the master processor, and configured to store first boot firmware and second boot firmware; and
a plurality of slave processors, each of the plurality of slave processors comprising a joint test action group (JTAG) port, and each JTAG port being connected to one input and output (I/O) port of the master processor;
wherein, when the master processor is powered on or rebooted, the master processor reads the first boot firmware and performs a booting process; after the master processor completes the booting process, it establishes communication connections with the plurality of slave processors respectively, and releases a reset signal to the plurality of slave processors respectively to control the startup of the plurality of slave processors, and reads the second boot firmware and transmits the second boot firmware to the plurality of slave processors through the communication connections to make the plurality of slave processors booted according to the received second boot firmware.

2. The multi-processor system according to claim 1, wherein the multi-processor system further comprises an expansion chip connected to the master processor, and the expansion chip is configured to make the master processor connect to more slave processors.

3. The multi-processor system according to claim 2, wherein the expansion chip is a programmable logic device or an application specific integrated circuit (ASIC) chip.

4. The multi-processor system according to claim 3, wherein the programmable logic device is a complex programmable logic device (CPLD) or a field-programmable gate array (FPGA).

5. The multi-processor system according to claim 3, wherein the ASIC chip is an inter-integrated circuit (I2C) to general-purpose input/output (GPIO) chip.

6. The multi-processor system according to claim 1, wherein each of the plurality of slave processor sends a booting success message to the master processor through the communication connection after being successfully booted according to the second boot firmware.

7. The multi-processor system according to claim 6, wherein the master processor control a certain slave processor to restart when the master processor does not receive the booting success message from the certain slave processor within default time after the second boot firmware is transmitted to the certain slave processor, and the master processor retransmits the second boot firmware to the certain slave processor through the communication connection, so that the certain slave processors is rebooted again according to the second boot firmware.

8. The multi-processor system according to claim 1, wherein the multi-processor system further comprises another non-volatile memory connected to the master processor, and configured to store the second boot firmware, so that the master processor selectively reads the second boot firmware from the non-volatile memory or the another non-volatile memory.

9. The multi-processor system according to claim 1, wherein the multi-processor system further comprises:
a first register, connected to each I/O port and configured to output clock signals to the plurality of slave processors in parallel;
a second register, connected to each I/O port and configured to output data input signals to the plurality of slave processors in parallel;
a third register, connected to each I/O port and configured to output mode selection signals to the plurality of slave processors in parallel; and
a fourth register, connected to each I/O port and configured to receive data output signals from the plurality of slave processors in parallel;
wherein the master processor controls each I/O port to be simulated as a JTAG port through the first register, the second register, the third register, and the fourth register, so that the master processor establishes the communication connection with each of the plurality of slave processor through the JTAG port included in each of the plurality of slave processors.

10. The multi-processor system according to claim 1, wherein the multi-processor system further comprises:
a first register, connected to each I/O port and configured to output clock signals to the plurality of slave processors in parallel;
a second register, connected to each I/O port and configured to output data input signals to the plurality of slave processors in parallel;
a third register, connected to each I/O port and configured to output mode selection signals to the plurality of slave processors in parallel;
a fourth register, connected to each I/O port and configured to receive data output signals from the plurality of slave processors in parallel; and
a fifth register, connected to each I/O port and configured to output reset signals to the plurality of slave processors in parallel;
wherein the master processor controls each I/O port to be simulated as a JTAG port through the first register, the second register, the third register, the fourth register, and the fifth register, so that the master processor establishes the communication connection with each of the plurality of slave processors through the JTAG port included in each of the plurality of slave processors.

11. The multi-processor system according to claim 1, wherein the multi-processor system further comprises a network exchange chip or a bus, and the master processor that has been successfully booted and the plurality of slave processors communicate with each other through the network exchange chip or the bus.

12. A booting method of a multi-processor system, comprising the following steps of:
reading, by a master processor, first boot firmware stored in a non-volatile memory when the master processor is powered on or rebooted and performing a booting process;
establishing, by the master processor, communication connections with a plurality of slave processors respectively after the master processor completes the booting process;
releasing, by the master processor, a reset signal to the plurality of slave processors respectively to control the startup of the plurality of slave processors; and
reading, by the master processor, second boot firmware and transmitting the second boot firmware to the plurality of slave processors through the communication connections to make the plurality of slave processors booted according to the received second boot firmware.

13. The booting method according to claim 12, wherein further comprising the step of:
sending, by each of the plurality of slave processors, a booting success message to the master processor through the communication connection after being successfully booted according to the second boot firmware.

14. The booting method according to claim 13, wherein comprising the step of:
controlling, by the master processor, a certain slave processor to restart when the master processor does not receive the booting success message from the certain slave processor within default time after the second boot firmware is transmitted to the certain slave processor, and retransmitting, by the master processor, the second boot firmware to the certain slave processor through the communication connection, so that the certain slave processors is rebooted again according to the second boot firmware.

15. The booting method according to claim 12, wherein the step of establishing, by the master processor, communication connections with the plurality of slave processors respectively after the master processor completes the booting process comprises:
controlling, by the master processor, each I/O port to be simulated as a JTAG port through a first register, a second register, a third register, and a fourth register, so that the master processor establishes the communication connection with each of the plurality of slave processors through the JTAG port included in each of the plurality of slave processors, wherein the first register, the second register, the third register and the fourth register are respectively connected to each I/O port; the first register, the second register and the third register is configured to output clock signals, data input signals and mode selection signals to the plurality of slave processors in parallel respectively; and the fourth register is configured to receive data output signals from the plurality slave processors in parallel.

16. The booting method according to claim 12, wherein the step of establishing, by the master processor, communication connections with the plurality of slave processors respectively after the master processor completes the booting process comprises:
controlling, by the master processor, each I/O port to be simulated as a JTAG port through a first register, a second register, a third register, a fourth register, and a fifth register, so that the master processor establishes the communication connection with each of the plurality of slave processors through the JTAG port included in each of the plurality of slave processors, wherein the first register, the second register, the third register, the fourth register, and the fifth register are respectively connected to each I/O port; the first register, the second register, the third register, and the fifth register are configured to output clock signals, data input signals, mode selection signals, and reset signals in parallel to the plurality of slave processors respectively; and the fourth register is configured to receive data output signals from the plurality slave processors in parallel.
